(19) United States
(12) Patent Application Publication
(10) Pub. No.: US 2026/0062110 A1
(43) Pub. Date: Mar. 5, 2026

(54) AIRCRAFT FUSELAGE SECTION, FUSELAGE SECTION AND AIRCRAFT FUSELAGE

(71) Applicant: Airbus Operations GmbH, HAMBURG (DE)

(72) Inventor: Jens LOHMAR, HAMBURG (DE)

(21) Appl. No.: 19/317,258

(22) Filed: Sep. 3, 2025

(30) Foreign Application Priority Data
Sep. 4, 2024 (DE) 102024125253.7

(51) Int. Cl. B64C 1/06; B64C 1/14

(52) U.S. Cl. CPC B64C 1/061; B64C 1/1492

(57) ABSTRACT

An aircraft fuselage portion including at least four frames arranged uniformly one behind the other in an aircraft longitudinal direction, a fuselage outer skin on an outer side of the frames and at least three window openings. Internal air ducting tube portions are arranged in intermediate regions extending between window openings and frames, and along the frames. All window openings are offset counter to the aircraft longitudinal direction, in each case by a linear amount defined between longitudinal central points of the window openings and central planes which are arranged in parallel between two adjacent frames. The intermediate regions are enlarged by the linear amount on common first longitudinal sides of each window opening, and the intermediate regions are smaller by the linear amount on the other, second, sides of each window opening. The tube portions are arranged in the enlarged intermediate regions.

### CROSS-REFERENCES TO RELATED APPLICATIONS

This application claims the benefit of the German Patent Application No. 102024125253.7 filed on Sep. 4, 2024, the entire disclosures of which are incorporated herein by way of reference.

### FIELD OF THE INVENTION

The invention relates to an aircraft fuselage portion, a fuselage section and an aircraft fuselage.

### BACKGROUND OF THE INVENTION

In the case of conventional aircraft, the cabin air distribution system supplies the cabin interior with air, which is introduced into the cabin interior via air outlets. These air outlets are located in the upper region of the cabin interior, in the region of the luggage bins. The air outlets are fed from the central mixer, which is arranged in the bottom deck below the cabin floor. It is therefore necessary to pass the air through riser tubes (“riser ducts”), which lead along the cabin side wall. The space between the cabin side wall and the outer skin of a corresponding aircraft fuselage portion is relatively restricted and is additionally limited by the frames of the fuselage and the window openings provided. In addition, it is also necessary to install primary and secondary muffling and insulating layers in this region of the aircraft fuselage. Overall, the installation of riser tubes in this region is therefore a laborious and expensive activity. There is thus a general interest in reducing the number of parts (especially the number of riser lines) that must be installed and secured in the aircraft fuselage or in fuselage sections.

It is an object of the present invention to provide an aircraft fuselage portion which enables quicker manufacture.

### SUMMARY OF THE INVENTION

This object of the invention is achieved by an aircraft fuselage portion comprising at least four frames arranged uniformly one behind the other in an aircraft longitudinal direction, a fuselage outer skin, which is arranged on an outer side of the frames, at least three window openings to receive transparent window panes, wherein the window openings are each formed in the fuselage outer skin in frame fields arranged between two adjacent frames, and comprising tube portions for internal air ducting, which are arranged in intermediate regions, which extend between window openings and frames, and along the frames. The aircraft fuselage portion according to the invention is distinguished by the fact that all the window openings are offset counter to the aircraft longitudinal direction, in each case by a linear amount, wherein the linear amount is in each case defined between central points of the window openings and central planes, which are arranged in parallel between two adjacent frames, that the intermediate regions are enlarged by the linear amount on first sides of the window openings, which first sides are aligned in the aircraft longitudinal direction, that the intermediate regions are made smaller by the linear amount on other, second, sides of the window openings, which second sides are aligned counter to the aircraft longitudinal direction, and that the tube portions for internal air ducting are arranged in the enlarged intermediate regions.

The aircraft fuselage portion according to the invention advantageously makes it possible to use the space obtained by the offset on one side of the window (intermediate region on the first side of a window opening) to install a single (relatively large) tube portion for internal air ducting (or riser ducts). According to the invention, the space correspondingly reduced by the offset on the other side of the window (intermediate region on the second side of a window opening) can remain free of air ducting tube portions (riser ducts). As a result, the installation effort for installing the air supply lines is virtually halved. More efficient, in particular quicker, manufacture of aircraft is thus advantageously possible.

A principal aspect of the invention is that all (at least three) the window openings of the aircraft fuselage portion according to the invention (comprising at least four frames and frame fields each extending therebetween) are offset counter to the aircraft longitudinal direction, in each case by a linear amount. In other words, an offset in a direction counter to the aircraft longitudinal direction is provided between the central points of the window openings and central planes, which are arranged in parallel between two adjacent frames. The offset V thus corresponds to the linear amount V. It is accordingly essential that, in the case of the aircraft fuselage portion according to the invention, the tube portions for internal air ducting (that is to say, the “riser ducts” or riser pipes) are arranged only in the enlarged intermediate regions. Accordingly, no tube portions for internal air ducting, that is to say, no riser ducts, are provided in the reduced-size intermediate regions. In other words: The reduced-size intermediate regions remain free from tube portions.

The fuselage structure of an aircraft is comprised substantially of a shell or outer skin, which is reinforced with frames and stringers on the inside thereof. Here, each hoop-like frame extends over the entire circumference of a fuselage cross section (360 degrees). The multiplicity of frames is arranged uniformly one behind the other in the aircraft longitudinal direction, that is to say, the frames are arranged at the same distance from one another. In the context of this disclosure, the term “aircraft longitudinal direction” is understood fundamentally to mean a direction which runs colinearly or parallel to the aircraft longitudinal axis from the tail end of the fuselage toward the cockpit.

It is self-evident that the above-described principal aspect of the invention can also alternatively be achieved by the at least three window openings of the aircraft fuselage portion being offset in the aircraft longitudinal direction, in each case by the linear amount, instead of being offset counter to the aircraft longitudinal direction. Accordingly, the enlarged and reduced-size intermediate spaces are formed in the opposite direction, but an enlarged intermediate space for receiving or installing a single (relatively large) tube portion for internal air ducting (or riser duct) is likewise formed.

This object of the invention is thus alternatively also achieved by an aircraft fuselage portion comprising at least four frames arranged uniformly one behind the other in an aircraft longitudinal direction, a fuselage outer skin, which is arranged on an outer side of the frames, at least three window openings to receive transparent window panes, wherein the window openings are each formed in the fuselage outer skin in frame fields arranged between two adjacent frames, and comprising tube portions for internal air ducting, which are arranged in intermediate regions, which extend between window openings and frames, and along the frames. According to the invention, the alternative aircraft fuselage portion is distinguished by the fact that all the window openings are offset in the aircraft longitudinal direction, in each case by a linear amount, wherein the linear amount is, in each case, defined between central points of the window openings and central planes, which are arranged in parallel between two adjacent frames, that the intermediate regions are enlarged by the linear amount on first sides of the window openings, which first sides are aligned counter to the aircraft longitudinal direction, that the intermediate regions are made smaller by the linear amount on other, second, sides of the window openings, which second sides are aligned in the aircraft longitudinal direction, and that the tube portions for internal air ducting are arranged in the enlarged intermediate regions.

One preferred embodiment of the fuselage portion is distinguished by the fact that the linear amount is between 20 mm and 40 mm. It has been found that the advantage associated with the invention in the case of a linear amount within such a value range is likewise obtained on common sizes of commercial aircraft types.

There is also a preference for a fuselage portion on which the linear amount is between 25 mm and 35 mm. In the case of such a value range for the linear amount, the advantage associated with the invention has been found to be very particularly pronounced. Most ideally, the linear amount is 30 mm.

In another preferred embodiment of the fuselage portion, the tube portions have an oval cross section. Tube portions of this kind are particularly suitable inasmuch as they can almost completely fill the typically rectangular cross section of the enlarged intermediate region and therefore almost no free space remains unused. One possible example of such an oval is a “superellipse”, also referred to as a “Lamé curve” or “Lamé oval”. To a certain extent, it represents a hybrid between an ellipse and a rectangle.

In one preferred further development of the fuselage portion, the tube portions are each formed by two individual tube portion elements firmly connected to one another. By virtue of the fact that the two individual tube portion elements are firmly connected to one another, they can be built into the cabin as a coherent object during installation. The effort involved in installation in the case of direct installation in the fuselage or the fuselage section or the fuselage portion is thus reduced, and manufacture can be accomplished even more quickly. The individual tube portion elements preferably have a diameter of 55 mm.

One particularly preferred further development of the preceding embodiment is distinguished by the fact that the individual tube portion elements each have circular cross sections. In this way, it is possible to achieve an advantageous flow behavior in the tube portion in respect of throughput and acoustics.

An alternative, particularly preferred further development is distinguished by the fact that the individual tube portion elements are connected to one another by a common flat plane. The common flat plane makes it possible to connect both individual tube portion elements to one another. In particular, it is thereby possible to form a one-piece or integral tube portion comprising the two individual tube portion elements. In the case of one-piece or integral tube portions, there is likewise the advantage that they can be built into the cabin as a coherent object during installation. The effort involved in installation in the case of direct installation in the fuselage portion is then likewise reduced, and manufacture can be accomplished quickly.

The object is also achieved by a fuselage section comprising a first fuselage section half, which is designed as a fuselage portion according to the invention, and a second fuselage section half, directly adjoining in the fuselage circumferential direction, wherein the second fuselage section half further comprises: frames arranged uniformly one behind the other in the aircraft longitudinal direction, a fuselage outer skin, which is arranged on an outer side of the frames, window openings to receive transparent window panes, wherein the window openings are each formed in the fuselage outer skin in frame fields arranged between two adjacent frames, and wherein the window openings are likewise offset counter to the aircraft longitudinal direction, in each case by the linear amount. The offset or the linear amount can then be provided in all the frame fields of the section according to the invention, and a uniform spacing is thus established from window opening to window opening, despite the offset. This also makes the fuselage section according to the invention easier to produce. The two fuselage section halves together form a fully circumferential fuselage section. It is self-evident that the above-described advantage of the fuselage section according to the invention can also alternatively be achieved by the window openings alternatively being offset in the aircraft longitudinal direction, in each case by the linear amount.

The object is also achieved by an aircraft fuselage comprising a fuselage portion according to the invention or comprising a fuselage section according to the invention, further comprising further frames arranged uniformly one behind the other in the aircraft longitudinal direction, an aircraft outer skin, which is arranged on an outer side of the frames, further window openings on each fuselage section side to receive transparent window panes, wherein the window openings are each formed in the fuselage outer skin in frame fields arranged between two adjacent frames, and wherein all the window openings are offset counter to the aircraft longitudinal direction, in each case by the linear amount. If the offset or the linear amount is provided in all the frame fields of the aircraft fuselage according to the invention, a uniform spacing is thus established from window opening to window opening, despite the offset or linear amount. This simplifies the production of the aircraft fuselage according to the invention. It is self-evident that the above-described advantage of the aircraft fuselage according to the invention can also alternatively be achieved by all the window openings alternatively being offset in the aircraft longitudinal direction, in each case by the linear amount.

The above-described aspects and further aspects, features and advantages of the invention can likewise be ascertained from the examples of the embodiment which is described below with reference to the appended drawings.

### BRIEF DESCRIPTION OF THE DRAWINGS

In the figures, the same reference signs are used for elements, components or aspects that are the same or at least similar. It is observed that, in the text which follows, embodiments are described in detail which are merely illustrative and not restrictive. In the claims, the word “having” does not exclude other elements, and the indefinite article “a/an” does not exclude a plurality. The mere fact that certain features are mentioned in different dependent claims does not limit the subject matter of the invention. Combinations of these features may also be used to advantage. The reference signs in the claims are not intended to limit the scope of the claims. The figures should not be interpreted as to scale but have only a schematic and illustrative character. In the drawings:

FIGS. 1a and 1b show side views of two previously known aircraft fuselage portions,

FIG. 2 shows a cutaway view through a cross section of a previously known aircraft fuselage portion in the region of a frame,

FIG. 3 shows a side view of an aircraft fuselage portion according to the invention,

FIGS. 4a to 4c show cutaway views through a cross section of an aircraft fuselage portion according to the invention in the region of a frame,

FIG. 5a shows a side view of a fuselage section according to the invention and FIG. 5b shows a plan view of the fuselage section according to the invention, and

FIG. 6 shows an aircraft according to the invention.

### DETAILED DESCRIPTION OF THE PREFERRED EMBODIMENTS

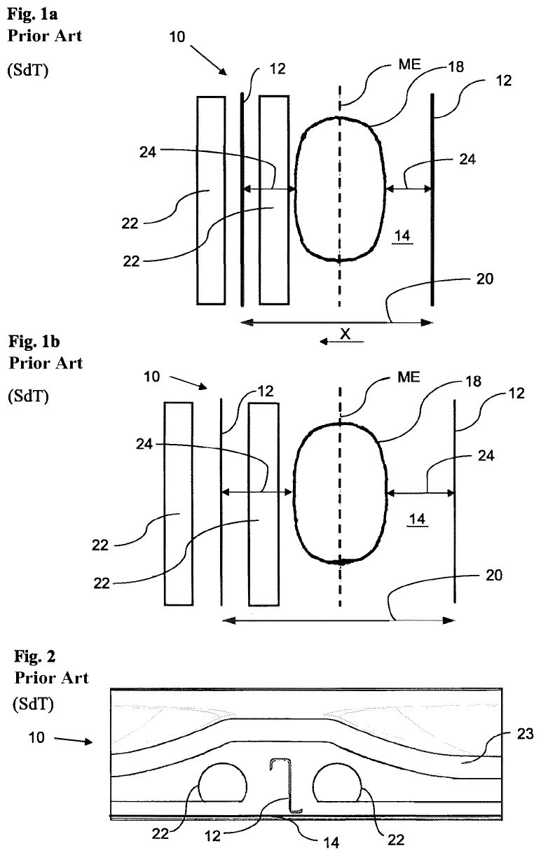

FIG. 1a and FIG. 1b show previously known aircraft fuselage portions 10. The aircraft fuselage portions comprise frames 12, which are arranged uniformly one behind the other in an aircraft longitudinal direction X. Furthermore, the aircraft fuselage portions 10 comprise a fuselage outer skin 14, which is arranged on an outer side of the frames 12. In addition, the aircraft fuselage portions 10 have window openings 18, which are suitable for receiving transparent window panes. The window openings 18 are each formed in the fuselage outer skin 14 in frame fields 20 arranged between two adjacent frames 12. The aircraft fuselage portions 10 furthermore comprise tube portions 22 for internal air ducting. Such tube portions 22 are portions of air ducting tubes (e.g. riser ducts), which are used in air distribution systems of commercial aircraft. The tube portions 22 are arranged in intermediate regions 24 and along the frames 12. The intermediate regions 24 extend from the window openings 18 (or from lateral edges of the window openings 18) to the frames 12.

FIG. 2 shows a cutaway view through a cross section of a previously known aircraft fuselage portion 10 in the region of a frame 12. Here too, as in FIG. 1, the tube portions 22 (or riser ducts 22) are routed or arranged along the main direction of extent of the frames 12. It can furthermore be seen that a side wall lining 23 is applied to the inner cabin side of the aircraft fuselage portion 10. Insulating layers are generally arranged between the side wall lining 23 and the fuselage outer skin 14. The space between the side wall lining 23 and the fuselage outer skin 14 of the aircraft fuselage portion 10 is relatively restricted and is also limited by the frames 12 and the window openings. The installation of the tube portions 22 (or riser tubes 22) in this space is generally a laborious task.

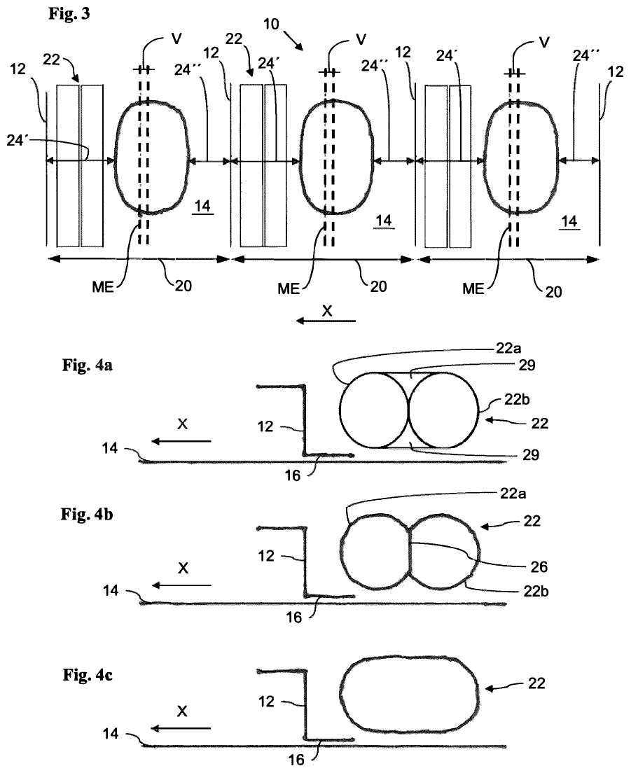

FIG. 3 illustrates a side view of an aircraft fuselage portion 10 according to the invention. This has at least four frames 12 arranged uniformly one behind the other in the aircraft longitudinal direction X. The aircraft fuselage portion 10 further comprises a fuselage outer skin 14, which is arranged on a circumferential outer side of the frames 12. In addition, the aircraft fuselage portion 10 has at least three window openings 18 to receive transparent window panes. The window openings 18 are each formed in frame fields 20 of the fuselage outer skin 14. A frame field 20 extends from a first frame 12 to an adjacent, second frame 12. The aircraft fuselage portion 10 also comprises tube portions 22 for internal air ducting, which are arranged in intermediate regions 24 and along the frames 12. The intermediate regions 24 extend between (lateral edges of) window openings 18 and (adjacent) frames 12.

According to the invention, all the window openings 18 are offset within each respective frame 12 counter to the aircraft longitudinal direction X, in each case by a linear amount V. In each case, the linear amount V is defined between longitudinal central points MP of the window openings 18 and central planes ME and is ideally on the order of 30 mm. The central planes ME, which are perpendicular to the longitudinal direction X, are arranged in parallel and centrally between two adjacent frames 12. The central planes ME are likewise arranged uniformly one behind the other in the aircraft longitudinal direction X. According to the invention, the intermediate regions 24′ are larger by the linear amount V on first sides of the window openings 18 (left sides of the window openings in the view of FIG. 3), which first sides are arranged in the aircraft longitudinal direction X (to the left in FIG. 3). According to the invention, the intermediate regions 24″ are correspondingly smaller by the linear amount V on other, second, sides of the window openings 18 (right sides of the window openings in the view of FIG. 3), which second sides are arranged counter to the aircraft longitudinal direction X (to the right in FIG. 3). Finally, according to the invention, the tube portions 22 for internal air ducting (or riser ducts) are arranged in the enlarged intermediate regions 24′. According to the invention, the reduced-size intermediate regions 24″ remain free from tube portions 22 for internal air ducting.

By means of the linear amount V, additional space is obtained on one side of the window openings 18 (enlarged intermediate regions 24′ on the first side of a window opening 18), which space can be used to build in or install a single tube portion 22 (either a relatively large tube portion or a tube portion built up from a plurality of individual elements) (cf. FIGS. 4a to 4c). In this way, it is possible, in principle, to virtually halve the number of tube portions 22 to be installed directly in the fuselage portion 10 while the flow cross section remains the same, as a result of which quicker installation is possible.

FIG. 4a shows a cutaway view through a cross section of an aircraft fuselage portion 10 according to the invention in the region of a frame 12. The fuselage outer skin 14 is arranged on an outer side 16 of the frames 12. In this embodiment, the tube portions 22 are each formed by two individual tube portion elements 22a, 22b firmly connected to one another. The two individual tube portion elements 22a, 22b can be positioned parallel to one another, e.g., by means of intermediate inserts 29, and then connected to one another by clamps (not illustrated). This is a simple, practical and effective connection possibility. It is self-evident that alternative connection possibilities also exist. In principle, the connection of the two individual tube portion elements 22a, 22b can take place in a work step that precedes direct installation in the aircraft fuselage portion 10 according to the invention. Thus, the work associated with the direct installation of the tube portion 22 is still halved when compared with the installation effort for two small riser ducts on both sides of the window openings 18.

Moreover, by virtue of the fact that the individual tube portion elements 22a, 22b each have circular cross sections, the flow which forms in the interior of the individual tube portion elements 22a, 22b during the operation of the air ducting system is optimized in respect of throughput and acoustics.

FIG. 4b shows another cutaway view through a cross section of an aircraft fuselage portion 10 according to the invention in the region of a frame 12. The fuselage outer skin 14 is arranged on an outer side 16 of the frames 12. In this embodiment of the invention, the individual tube portion elements 22a, 22b are connected to one another by a common flat plane 26.

FIG. 4c likewise shows a cutaway view through a cross section of an aircraft fuselage portion 10 according to the invention in the region of a frame 12, wherein the tube portion 22 has an oval cross section. The fuselage outer skin 14 is arranged on an outer side 16 of the frames 12.

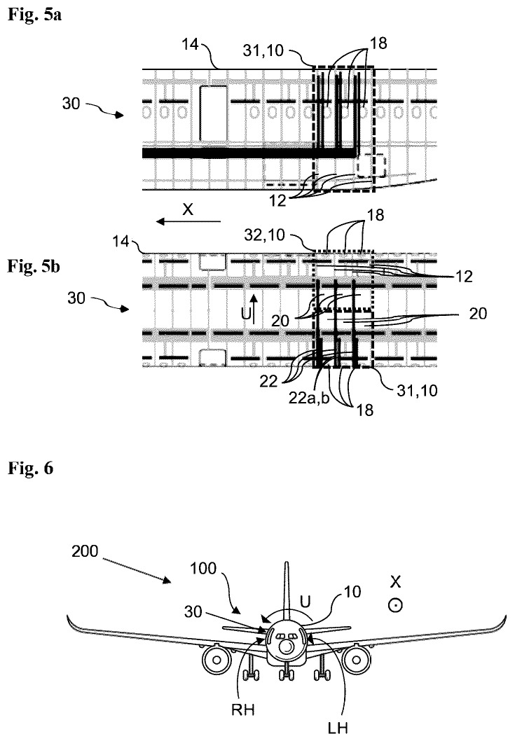

FIG. 5a shows a side view of a fuselage section 30 according to the invention and FIG. 5b shows a plan view of this fuselage section 30 according to the invention.

The fuselage section 30 comprises a first fuselage section half 31, which is designed as a fuselage portion 10 (that is to say, in accordance with FIG. 3), i.e., it has four frames 12 and three frame fields 20 arranged between them, as well as, for each frame field 20, a tube portion 22 arranged therein along the respective frame 12. Here, by way of example, the tube portions 22 are each designed and built in or installed as double individual tube portion elements 22a, 22b with circular cross sections.

The fuselage section 30 furthermore comprises a second fuselage section half 32 directly adjoining in the fuselage circumferential direction U. As can be seen from FIG. 5b, the second fuselage section half 32 furthermore comprises frames 12 arranged uniformly one behind the other in the aircraft longitudinal direction X, a fuselage outer skin 14, which is arranged on an outer side of the frames 12, and window openings 18 to receive transparent window panes. The window openings 18 are each formed in the fuselage outer skin 14 in frame fields 20 arranged between two adjacent frames 12. The window openings 18 are likewise offset counter to the aircraft longitudinal direction X, in each case by the linear amount V (in a manner similar to FIG. 3). Thus, in contrast to the first fuselage section half 31, there are no tube portions 22 for internal air ducting in the second fuselage section half 32. The fuselage section 30 can furthermore comprise further aircraft fuselage portions (e.g., fuselage portions directly adjoining in the aircraft longitudinal direction X).

Finally, FIG. 6 illustrates an aircraft fuselage 100 for an aircraft 200. The aircraft fuselage 100 comprises a fuselage portion 10 according to the invention or a fuselage section 30 according to the invention. The aircraft fuselage portion 100 further comprises further frames 12 arranged uniformly one behind the other in the aircraft longitudinal direction X, and a fuselage outer skin 14, which is arranged on an outer side of the frames 12. In addition, the aircraft fuselage 100 has additional window openings 18 on the right-hand fuselage section side RH and on the left-hand fuselage section side LH to receive transparent window panes. The window openings 18 are each formed in the fuselage outer skin 14 in frame fields 20 that extend between two adjacent frames 12. The window openings 18 are offset counter to the aircraft longitudinal direction X (in a manner similar to FIG. 3), in each case by the linear amount V.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft fuselage portion comprising:
at least four frames arranged uniformly one behind the other in an aircraft longitudinal direction,
a fuselage outer skin, which is arranged on a circumferential outer side of the frames,
at least three window openings to receive transparent window panes,
wherein the window openings are each formed in the fuselage outer skin in frame fields arranged between two adjacent frames, and comprising tube portions for internal air ducting, which are arranged in intermediate regions, the intermediate regions extending between window openings and frames, and along the frames,
wherein all the window openings are offset counter to the aircraft longitudinal direction within each frame, in each case by a linear amount, wherein the linear amount is, in each case, defined between longitudinal central points of the window openings and central planes arranged perpendicular to the longitudinal direction, which central planes are arranged in parallel between two adjacent frames,
the intermediate regions are larger by the linear amount on first sides of the window openings, which first sides are arranged in the aircraft longitudinal direction,
the intermediate regions are smaller by the linear amount on other, second, sides of the window openings, which second sides are arranged counter to the aircraft longitudinal direction, and
the tube portions for internal air ducting are arranged in the enlarged intermediate regions.

2. The fuselage portion as claimed in claim 1, wherein the linear amount is between 20 mm and 40 mm.

3. The fuselage portion as claimed in claim 1, wherein the linear amount is between 25 mm and 35 mm.

4. The fuselage portion as claimed in claim 1, wherein the linear amount is 30 mm.

5. The fuselage portion as claimed in claim 1, wherein the tube portions have an oval cross section.

6. The fuselage portion as claimed in claim 1, wherein the tube portions are each formed by two individual tube portion elements firmly connected to one another.

7. The fuselage portion as claimed in claim 6, wherein the individual tube portion elements each have a circular cross section.

8. The fuselage portion as claimed in claim 6, wherein the individual tube portion elements are connected to one another by a common flat plane.

9. A fuselage section comprising a first fuselage section half, which comprises a fuselage portion as claimed in claim 1, and a second fuselage section half, directly adjoining in a fuselage circumferential direction, wherein the second fuselage section half further comprises:
frames arranged uniformly one behind the other in the aircraft longitudinal direction,
a fuselage outer skin, which is arranged on the circumferential outer side of the frames,
window openings to receive transparent window panes,
wherein the window openings are each formed in the fuselage outer skin in frame fields arranged between two adjacent frames, and
wherein the window openings are offset in each frame counter to the aircraft longitudinal direction, in each case by the linear amount.

10. An aircraft fuselage comprising a fuselage portion as claimed in claim 1, further comprising:
further frames arranged uniformly one behind the other in the aircraft longitudinal direction,
an aircraft outer skin, which is arranged on the circumferential outer side of the frames,
further window openings on each fuselage section side to receive transparent window panes,
wherein the window openings are each formed in the fuselage outer skin in frame fields arranged between two adjacent frames, and
wherein all the window openings are offset counter to the aircraft longitudinal direction, in each case by the linear amount.

11. An aircraft fuselage comprising a fuselage section as claimed in claim 9, further comprising:
further frames arranged uniformly one behind the other in the aircraft longitudinal direction,
an aircraft outer skin, which is arranged on the circumferential outer side of the frames,
further window openings on each fuselage section side to receive transparent window panes,
wherein the window openings are each formed in the fuselage outer skin in frame fields arranged between two adjacent frames, and
wherein all the window openings are offset counter to the aircraft longitudinal direction, in each case by the linear amount.
